(19) United States
(12) Patent Application Publication
(10) Pub. No.: US 2020/0055349 A1
(43) Pub. Date: Feb. 20, 2020

(54) Tread Comprising A Long Tread Bar Having A Plurality Of Cut-Outs

(71) Applicant: COMPAGNIE GENERALE DES ETABLISSEMENTS MICHELIN, Clermont-Ferrand (FR)

(72) Inventors: Benoit DURAND-GASSELIN, Clermont-Ferrand Cedex 9 (FR); Olivier MUHLHOFF, Clermont-Ferrand Cedex 9 (FR)

(21) Appl. No.: 16/346,944

(22) PCT Filed: Oct. 31, 2017
(86) PCT No.: PCT/FR2017/053000

§ 371 Date: May 2, 2019

(30) Foreign Application Priority Data
Nov. 3, 2016 (FR) 1660634

(51) Int. Cl. B60C 11/04; B60C 11/12; B60C 11/13

(52) U.S. Cl. CPC B60C 11/04; B60C 11/1218; B60C 2011/0358; B60C 11/1281; B60C 11/1307; B60C 11/1236

(57) ABSTRACT

Tread for a tire, having an elongate block (3) extending in a circumferential direction and having a contact surface (5) intended to come into contact with the ground, a first and a second lateral wall delimiting said contact surface (5), the elongate block having a plurality of cuts that each have a first and a second end, the cuts (n, n+1) longitudinally following one another on the contact surface (5) such that, when one cut (n) reaches its second end, another cut (n+1) starts, at one and the same circumferential level on the elongate block (3). Moreover, all or some of the sipes (n, n+1) have at least one narrowing protrusion protruding from a wall of the cut.

### FIELD OF THE INVENTION

The present invention relates to a tread for a motor vehicle tire provided with means for substantially reducing running noise.

### PRIOR ART

As is known, a tread of a tire has a set of cuts with the objective of improving the grip of the tire, in particular on wet ground. Such cuts are grooves and/or sipes.

It is also known that the presence of cuts in a tread can be a source of noise associated, inter alia, with vibrations of the air flowing in the grooves, notably in the zone of contact with the road surface, or with a non-optimal distribution of the sipes during running.

With the development of increasingly quiet vehicles, in particular electric vehicles, such noise is becoming annoying.

One solution is proposed by the document WO2015067644, which discloses a tread having a plurality of sipes arranged so as to limit the noise that can be generated by these sipes.

However, it has been found that, under certain running conditions, the blocks of rubbery material having such sipes produce noise partly due to the hammering of the blocks of rubbery material of which they are made as they enter the contact patch, when they come into contact with the ground.

Specifically, each pair of successive sipes forms a sub-block of material of the tread. While the tire is running, each sub-block passes through a phase of high contact pressure with the ground, then through a phase referred to as the escape phase in which the contact pressure decreases, just before the sub-block leaves the ground. In this escape phase, a portion of each sub-block slides over the ground.

As the blocks situated on the ground are compressed, they lose height. Since the blocks arriving at the start of the contact patch have a greater height, they hit the ground before they are compressed, thereby generating noise.

This problem is accentuated even further on the treads of modern tires which have increasingly low moduli, and therefore a greater loss of height.

Therefore, the object of the invention is to reduce the noise brought about by the hammering of the blocks of rubbery material while the tire is running.

### Definitions

In the following description, the following definitions will apply:
A “tire” means all types of resilient tread, whether or not it is subjected to an internal pressure.
The “tread” of a tire means a quantity of rubbery material delimited by lateral surfaces and by two main surfaces, one of which is intended to come into contact with a road surface when the tire is being driven on.
The “tread surface” means the set of points of the tread that are in contact with the road surface when the tire, inflated to its reference pressure, is running on this road surface. The reference inflation pressure is defined under the use conditions of the tire as defined notably by the E.T.R.T.O. (“European Tire and Rim Technical Organisation”) standard. The width C of the tread surface is notably defined by the ETRTO standard such that C=(1.075-0.005ar)*S1.001, where ar is the nominal aspect ratio and s is the theoretical section width on a measuring rim.
A “block” on a tread means a raised element delimited by grooves and comprising lateral walls and a contact face, the latter being intended to come into contact with the ground during running.
An “elongate block” means a block having a width and a length around the circumference of the tire, this length being much greater than the width.
A “groove” means a cut in the tread delimiting walls of material, the width corresponding to the spacing between the walls of this cut being such that the walls associated with this cut cannot come into contact with one another under normal running conditions. The width of a groove is greater than 2 millimetres.
A “sipe” means a cut in the tread delimiting walls of material, the width corresponding to the spacing between the walls of this cut being suitable for allowing the walls of the sipe to come at least partially into contact as they pass through the contact patch in which the tire is in contact with the ground. The width of a sipe is less than or equal to 2 millimetres.
A “cut” means a groove or a sipe.
A “transverse direction” or “axial direction” means a direction parallel to the axis of rotation of the tire.
A “circumferential direction” means a direction tangential to any circle centred on the axis of rotation of the tire. This direction is perpendicular to the axial direction.
An “oblique direction” means a direction that has an axial component and a circumferential component, neither of which is zero.
A “circumferential level” means a set of points that form a straight line, this straight line being perpendicular to the circumferential direction.

### SUMMARY OF THE INVENTION

The invention relates to a tread for a tire, having at least one elongate block of rubbery material of width W and length L, where L>>W, said elongate block extending in a circumferential direction when the tread is mounted on the tire, each elongate block having a contact surface intended to come into contact with the ground and a first lateral wall and a second lateral wall delimiting said contact surface, the elongate block having a plurality of N successive oblique cuts that each have a first end and a second end, at least one of the first end and the second end opening onto the first or second lateral wall. Moreover, the cuts longitudinally follow one another on the contact surface such that at least one of the ends of one of the cuts is at the same circumferential level x on the elongate block as one end of another cut.

The invention thus proposes ensuring continuity in the organization of the sipes in the elongate block. Specifically, at least one of the ends of one of the cuts is at the same circumferential level on the elongate block as one end of another cut. In other words, when a cut reaches one of its ends, another cut starts at the same circumferential level.

This limits the variation in the void ratio in the circumferential direction in the elongate block and the acoustic performance of the tire is improved as a result.

In addition, all or some of the cuts have at least one narrowing protrusion protruding from a wall of the cut.

This geometry thus provides for the distance between the walls of the cuts to narrow. As a result of this proximity of the walls, in the high-pressure phase, when the tread is flattened in contact with the ground, the walls come into contact with one another and thus block the decrease in height of the blocks formed by the sipes. Thus, the difference in height between the blocks that are already in contact with the ground and the blocks that are coming into contact with the ground is reduced. Consequently, the phenomenon of striking is reduced, making it possible to reduce the noise emitted by the tire.

Advantageously, the narrowing protrusion extends up to the contact surface.

In this way, better blocking of the blocks is ensured and the phenomenon of striking is reduced.

Advantageously, the cut narrows over at least 20% of the height of said sipe 20% or surface of the wall from which the protrusion protrudes.

According to one variant, the wall of the cut opposite the protrusion is inclined.

This improves the pattern of wear.

According to another variant, the narrowing is formed by two facing protrusions that protrude from opposite walls of the cut.

In this way, the rolling resistance of the tire is improved.

Advantageously, the width of the protrusion decreases away from the wall from which said protrusion protrudes.

In this way, the rolling resistance of the tire is also improved, and the risk of cracking at the base of the protrusions is reduced.

Advantageously, the cut is wholly or partially chamfered at the surface of the tread.

This makes it possible to improve the braking performance of the tire on dry ground.

Advantageously, the width of the cut at the narrowing is less than or equal to 0.7 mm.

The rolling resistance of the tire is improved and the noise is reduced.

Advantageously, the width of the cut at the narrowing is between 0.3 mm and 0.5 mm.

The rolling resistance of the tire is improved further and the noise is reduced further.

According to one exemplary embodiment, at least one cut has a maximum depth of between 50% and 100% of the height of the first and/or second lateral wall.

This makes it possible to enhance the longitudinal stiffness of the tread, thereby improving braking on dry ground.

According to one variant, at least one cut has a maximum radial depth of between 80% and 95% of the height of the first and/or second lateral wall. This makes it possible to enhance the longitudinal stiffness and thus braking on wet ground.

According to one exemplary embodiment, each cut has its first end opening into the first lateral wall and its second end opening into the second lateral wall.

This makes the tire more flexible and able to be flattened better. Consequently, the energy dissipated on each wheel rotation decreases.

According to one variant, each cut has its first end opening into the first lateral wall and its second end not opening into the second lateral wall, or each cut has its first end opening into the second lateral wall and its second end not opening into the first lateral wall.

This makes it possible to enhance the longitudinal stiffness and thus braking on dry ground.

According to one variant, for a first cut and a second cut which longitudinally follow one another in the elongate block and each have a first end opening into the first lateral wall, the second end of the first cut opens into the second lateral wall and the second end of the second cut does not open into the second lateral wall.

The sipes opening onto the second lateral wall form sub-blocks in the elongate block. Each sub-block thus comprises a cut that does not open onto this second lateral wall. This promotes the flattening of the elongate block.

This also makes it possible to enhance the longitudinal stiffness and consequently braking on dry ground.

Advantageously, the cut is a groove. This improves the flow of water out of the tread when the tire is running on wet ground.

In this case, the same level on the tread means that for two successive grooves on the tread, the second end of the first groove is adjacent to the first end of the second groove.

Advantageously, the cut is a sipe. This improves the grip of the tread on wet ground without excessively reducing the overall stiffness of the elongate block.

The invention also relates to a tire having a tread as described above.

### BRIEF DESCRIPTION OF THE DRAWINGS

Further features and advantages of the invention will become apparent from the following description, given by way of non-limiting example, with reference to the attached drawings, in which:

FIG. 1 schematically shows a partial view of a tread according to a first exemplary embodiment of the invention;

FIGS. 2 to 5 illustrate examples of profiles in the depth of the tread of a sipe according to the invention;

FIGS. 6 to 8 illustrate examples of grooves according to the invention.

### DETAILED DESCRIPTION

In the following description, elements which are substantially identical or similar will be denoted by identical references.

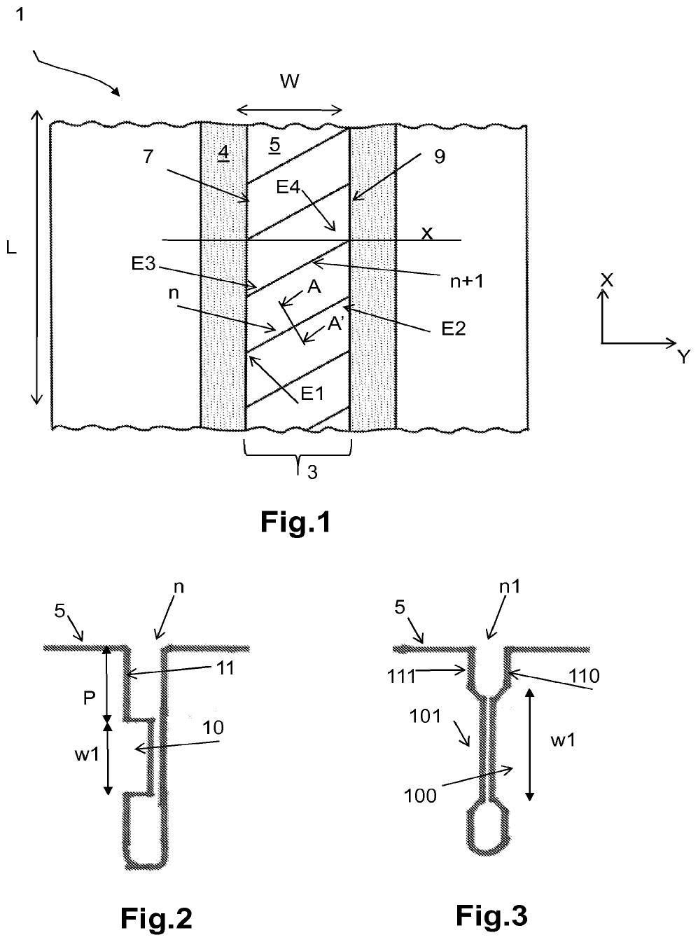

FIG. 1 shows a partial view of a tread 1 of a tire according to a first embodiment of the invention.

The tread 1 comprises at least one block 3 of rubbery material. The block 3 is delimited here by two grooves 4, which have been shaded grey in FIG. 1 to make the invention easier to understand. More specifically, the block 3 has a width W and a length L, this length L being very much greater than the width W. The expression “very much greater” means that the length L is at least equal to 5 times the width W. In this way, when the tread 1 is mounted on a tire, the block 3 looks like a strip extending in a circumferential direction X. This strip may extend all around the circumference of the tire. In a variant, this strip extends around only part of this circumference.

In addition, the block 3 has a contact surface 5 intended to come into contact with the ground, and a first lateral wall 7 and a second lateral wall 9 delimiting this contact surface 5.

Moreover, the block 3 has a plurality of sipes n, n+1 opening onto the contact surface 5. The sipes n, n+1 extend in an oblique direction, opening onto the first lateral wall 7 with their respective first ends E1, E3 and onto the second lateral wall 9 by way of their respective second ends E2, E4.

The sipes n, n+1 of the block 3 are in this case oriented in the same direction, that is to say the sipes extend from the first lateral wall 7 towards the second lateral wall 9 in a direction that is positive in X and Y. These sipes are distributed over the contact surface 5 of the block 3 in such a way that when one sipe n reaches the second lateral wall 9, another sipe n+1 starts from the first lateral wall 7, substantially at the same level on the block 3.

The expression “at the same level x” on the block means a determined circumferential position x on this block. In addition, “substantially” means that there may be a slight offset between the circumferential position of the sipes n, n+1. This offset is limited, however. It is preferably less than 5% of the spacing between the two sipes n, n+1 delimiting the sub-block 8. In order to assess whether or not such an offset is present, use is made of the idea of a neutral axis associated with each sipe.

Moreover, each sipe n, n+1 has a narrowing protrusion which narrows the distance between the walls of the sipes. In particular, the narrowing starts from a certain depth.

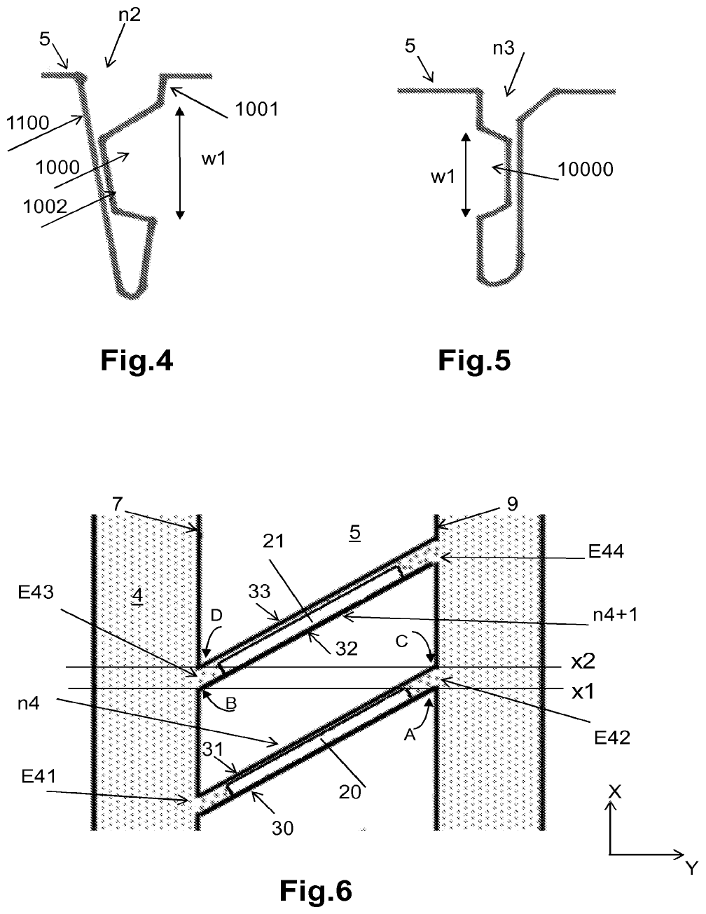

FIG. 2 illustrates a cross-sectional view on the axis A-A′ in FIG. 1 illustrating the profile in the depth of the tread of a sipe n according to a first exemplary embodiment. In this exemplary embodiment, the sipe n has, at a depth P of the tread, a narrowing protrusion 10 protruding from a wall 11 of the sipe n.

FIG. 3 is a variant in which the narrowing of the sipe is formed by two facing protrusions 100, 101. Each protrusion 100, 101 protrudes from a wall 110, 111 of the sipe n1.

FIG. 4 is another variant, in which the wall 1100 of the cut n2 opposite the protrusion 1000 is inclined. It will also be noted that the protrusion 1000 protruding from the opposite wall 1001 has a wall 1002 adjacent to the inclined walls 1100 and parallel thereto.

FIG. 5 is another variant, in which the sipe n3 has a chamfer at the surface of the tread.

It will be noted that in the example in FIG. 2 the protrusion 10 has a fixed width, while in the examples in FIGS. 3, 4 and 5 the width w1 of the protrusions 100, 101; 1000; 10000 decreases away from the wall from which each protrusion protrudes.

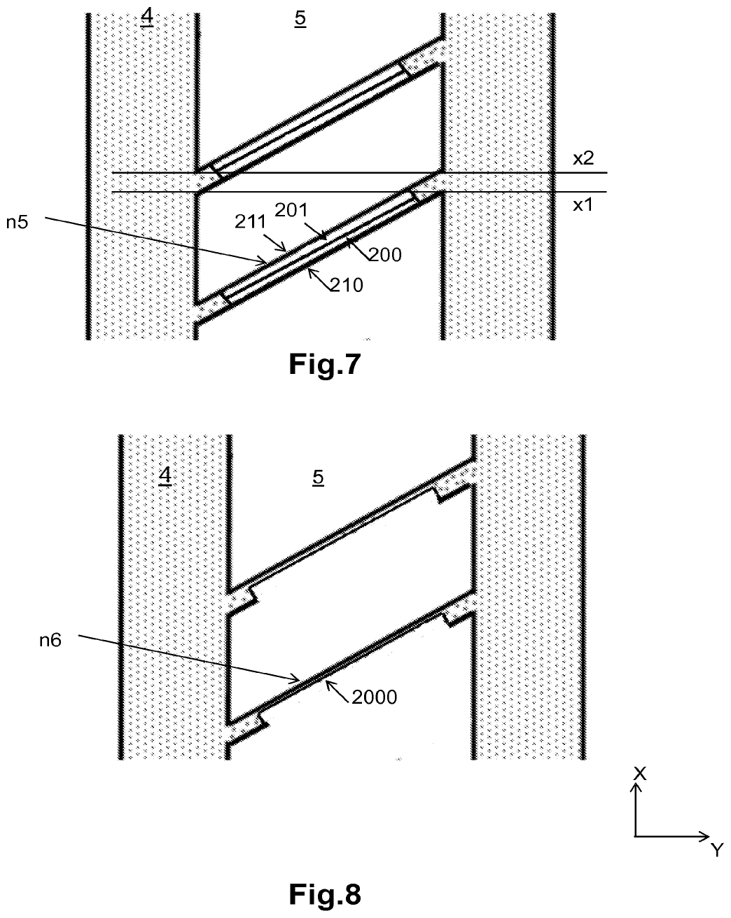

FIG. 6 illustrates an example of two grooves n4, n4+1 according to the invention which follow one another on the tread 5. The groove n+4 has a first end E41 and a second end E42 and the groove n4+1 has a first end E43 and a second end E44. The ends E42 and E43 are adjacent to one another on the tread.

In particular, the upper end A of the lower wall of the groove n4 is aligned, at the level x1 in the circumferential direction X, with the lower end B of the lower wall 32 of the groove n4+1. Furthermore, the upper end C of the upper wall 31 of the groove n4 is aligned, at the level x2 in the circumferential direction X, with the lower end D of the upper wall 33 of the groove n4+1.

In addition, each of the grooves n4, n4+1 has a narrowing protrusion 20, 21 protruding from a wall 30, 31 of the groove n4, n4+1.

FIG. 7 is a variant in which the narrowing of each groove n5 is formed by two facing protrusions 200, 201. Each protrusion 200, 201 protrudes from a wall 210, 211 of the groove n5.

It will be noted that in the examples in FIGS. 6 and 7, the narrowing protrusions 20; 200, 201 are at a certain depth in the contact surface 5 of the tread.

FIG. 8 illustrates another variant, in which the narrowing protrusion 2000 of the groove n6 extends up to the contact surface 5 of the tread.

It will also be noted that for the examples in FIGS. 6 to 8, the narrowing along the length of the grooves n4, n5, n6 is partial, in this case in a central portion.

In a variant that is not illustrated, the lengths of the cuts n, n+1 are shorter. The ends E2, E4 are then separated by a distance D. This distance D has a transverse component at least equal to 10% of the width W of the elongate block.

In a variant that is not illustrated, the elongate block has a series of oblique sipes n, n+1 that open onto the first lateral wall 7 and extend as far as ends E2, E4 of sipes that do not open onto the lateral walls 7, 9. The ends E2, E4 are in this case located on a median plane of the tread.

The sipes n, n+1 are distributed over the contact surface 5 such that when the cut n reaches its cut end E2, another cut n+1 starts from the first lateral wall 7, substantially at the same circumferential level x on the elongate block 3.

Thus, when the sipes n, n+1 are projected in the circumferential direction X, sipes are not superimposed in this circumferential direction X. This limits the variation in the void ratio in the elongate block 3 in this circumferential direction.

It will also be noted that, since the sipes n, n+1 do not pass through the elongate block 3, good overall stiffness of the elongate block 3 is ensured.

In a variant that is not illustrated, the cut n does not open into the second lateral wall 9 and the cut n+1 opens onto the second lateral wall 9 such that the elongate block 3 is formed by a plurality of sub-blocks.

According to one non-limiting embodiment, at least one cut has a maximum depth of between 50% and 100% of the height of the first and/or second lateral wall 7, 9. This depth is measured from the contact surface 5.

According to one variant, at least one cut has a maximum depth of between 80% and 95% of the height of the first and/or second lateral wall 7, 9.

The invention is not limited to the examples described and shown and various modifications can be made thereto without departing from its scope.

1. Tread for a tire, the tread comprising at least one elongate block of rubbery material of width W and length L, where L>>W, said elongate block extending in a circumferential direction when the tread is mounted on the tire, each said elongate block having a contact surface, adapted to come into contact with the ground, and a first lateral wall and a second lateral wall delimiting said contact surface, said elongate block having a plurality of N successive oblique cuts that each have a first end and a second end, at least one of the first end and the second end opening onto the first lateral wall or second lateral wall, wherein the oblique cuts longitudinally follow one another on said contact surface such that at least one of the first and second ends of one of the oblique cuts is at the same circumferential level on said elongate block as one of the first and second ends of another of said oblique cuts, and wherein all or some of the oblique cuts have at least one narrowing protrusion protruding from a wall of the cut.

2. The tread according to claim 1, wherein the narrowing protrusion extends up to the contact surface.

3. The tread according to claim 1, wherein the cut narrows over at least 20% of the height of said cut.

4. The tread according to claim 1, wherein the cut narrows over at least 20% of the surface of the wall from which the protrusion protrudes.

5. The tread according to claim 1, wherein the wall of the cut opposite the protrusion is inclined.

6. The tread according to claim 1, wherein the narrowing is formed by two facing protrusions that protrude from opposite walls of the cut.

7. The tread according to claim 1, wherein the width of the protrusion decreases away from the wall from which said protrusion protrudes.

8. The tread according to claim 1, wherein the cut is wholly or partially chamfered at the surface of the tread.

9. The tread according to claim 1, wherein the width of the cut at the narrowing is less than or equal to 0.7 mm.

10. The tread according to claim 1, wherein the width of the cut at the narrowing is between 0.3 mm and 0.5 mm.

11. The tread according to claim 1, wherein the cuts are sipes.

12. The tread according to claim 1, wherein the cuts are grooves.

13. A tire comprising a tread according to claim 1.
